(19) United States
(12) Patent Application Publication
(10) Pub. No.: US 2025/0187845 A1
(43) Pub. Date: Jun. 12, 2025

(54) MACHINE VISION INSPECTION OF WAFER PROCESSING TOOL

(71) Applicant: Lam Research Corporation, Fremont, CA (US)

(72) Inventors: Liu YANG, Portland, OR (US); Mengping LI, Tigard, OR (US); Shantinath GHONGADI, Tigard, OR (US)

(21) Appl. No.: 18/683,942

(22) PCT Filed: Aug. 21, 2022
(86) PCT No.: PCT/US2022/075249

§ 371 Date: Feb. 15, 2024

Related U.S. Application Data
(60) Provisional application No. 63/260,891, filed on Sep. 3, 2021.

(51) Int. Cl. B65G 43/10; G05B 13/02; G06V 10/764; G06V 10/82

(52) U.S. Cl. CPC B65G 43/10; G05B 13/027; G06V 10/764; G06V 10/82; G06V 2201/06

(57) ABSTRACT

Examples are disclosed that relate to diagnosing a condition of a wafer processing tool using a machine learning classifier. One example provides an electrodeposition tool comprising a cup. The cup comprises a wafer interface. The wafer interface comprises a lip seal and a plurality of electrical contacts. The electrodeposition tool further comprises a camera positioned to image at least a portion of the wafer interface. The electrodeposition tool further comprises a logic machine, and a storage machine storing instructions executable by the logic machine. The instructions are executable to acquire an image of the wafer interface via the camera. The instructions are further executable to obtain a classification of the image of the wafer interface from a trained machine learning function. The instructions are further executable to control the electrodeposition tool to take an action based on the classification.

### BACKGROUND

A wide variety of processing tools are used to form integrated circuits on wafer substrates. For example, electrodeposition is commonly used in integrated circuit manufacturing processes to form electrically conductive structures.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to diagnosing a condition of a wafer processing tool using a machine learning classifier. One example provides an electrodeposition tool comprising a cup. The cup comprises a wafer interface. The wafer interface comprises a lip seal and a plurality of electrical contacts. The electrodeposition tool further comprises a camera positioned to image at least a portion of the wafer interface. The electrodeposition tool further comprises a logic machine, and a storage machine storing instructions executable by the logic machine. The instructions are executable to acquire an image of the wafer interface via the camera. The instructions are further executable to obtain a classification of the image of the wafer interface from a trained machine learning function. The instructions are further executable to control the electrodeposition tool to take an action based on the classification.

In some such examples the wafer interface is configured to rotate, and the camera is configured to capture a plurality of images of the wafer interface at a corresponding plurality of angles of rotation of the wafer interface.

In some such examples the instructions are additionally or alternatively executable to obtain a classification of each image of the plurality of images.

In some such examples the instructions are additionally or alternatively executable to transmit the image of the wafer interface to a remote computing system hosting the trained machine learning function, and to obtain the classification of the image from the remote computing system.

In some such examples the trained machine learning function comprises a residual neural network.

In some such examples the instructions are additionally or alternatively executable to control the electrodeposition tool to execute a cleaning program in response to obtaining a classification of dirty.

In some such examples the instructions are additionally or alternatively executable to control the electrodeposition tool to execute a cell drying program in response to obtaining a classification of wet.

In some such examples the instructions are additionally or alternatively executable to control the electrodeposition tool to output an error code for user intervention in response to obtaining a classification of damaged.

In some such examples the instructions are additionally or alternatively executable to control the electrodeposition tool to continue normal operation in response to obtaining a classification of one of normal or ambiguous.

Another example provides a method for operating an electrodeposition tool. The method comprises acquiring an image of a wafer interface of the electrodeposition tool via a camera. The method further comprises obtaining a classification of the image from a trained machine learning function. The method further comprises, upon obtaining the classification, controlling the electrodeposition tool to execute a maintenance program based upon the classification.

In some such examples, the classification comprises a dirty classification, and the maintenance program comprises a cell cleaning program.

Additionally or alternatively, in some such examples the classification comprises a wet classification, and the maintenance program comprises a cell drying program.

Additionally or alternatively, in some such examples the classification comprises a damage classification, and the maintenance program comprises outputting an error code for user intervention.

Additionally or alternatively, in some such examples the method further comprises acquiring a plurality of images of the wafer interface at a corresponding plurality of angles of rotation of the wafer interface, and obtaining a classification of each image of the plurality of images from the trained machine learning function.

Additionally or alternatively, in some such examples the method further comprises obtaining a classification of normal, and controlling the electrodeposition tool to continue normal operation.

Additionally or alternatively, in some such examples the method further comprises obtaining an ambiguous classification, and, in response, triggering a warning code.

Another example provides a computing system comprising a logic machine and a storage machine holding instructions executable by the logic machine. The instructions are executable to obtain an image of a wafer interface of an electrodeposition tool, the wafer interface comprising a lip seal and a plurality of electrical contacts. The instructions are further executable to obtain a classification via inputting the image into a trained machine learning function. The instructions are further executable to output the classification.

In some such examples, the trained machine learning function comprises a residual neural network.

Additionally or alternatively, in some such examples the instructions are further executable to crop the image of the wafer interface prior to inputting the image into the trained machine learning function.

Additionally or alternatively, in some such examples the instructions are further executable to train the trained machine learning function using labeled training images that are each labeled with a classification of one of normal, wet, dirty, or damaged.

### BRIEF DESCRIPTION OF THE DRAWINGS

FIG. 1 shows a block diagram of an example wafer processing tool in the form of an electrodeposition tool including a camera.

FIG. 2 shows a schematic sectional view of an example plating cell for an electrodeposition tool.

FIGS. 3A-3B show an example electrodeposition tool clamshell.

FIG. 4 shows a flow diagram of an example method for operating an electrodeposition tool.

FIGS. 5A-5B schematically show an example wafer interface configured to rotate for imaging.

FIG. 6 schematically shows an example wafer interface and a plurality of cameras positioned to image the wafer interface.

FIG. 7 shows a schematic representation of an example residual neural network.

FIG. 8 shows a flow diagram of an example method for training a machine learning function to classify images of a wafer processing tool.

FIG. 9 shows a block diagram of an example computing system.

### DETAILED DESCRIPTION

As discussed above, electrodeposition is commonly used in the fabrication of integrated circuits. Electrodeposition also may be referred to as electroplating and electrofill. Electrodeposition involves electrochemically reducing metals ions in a plating solution onto a wafer surface to deposit solid metal onto the wafer surface. Electrodeposition can be used to fill recessed patterns formed in a wafer surface with a metal. In an example process, a seed layer of metal is deposited onto the wafer surface by physical vapor deposition. Then, the wafer surface is exposed to a plating solution comprising metal ions. An electric current is applied to reduce the metal ions. The electrochemical reduction grows a thicker layer of metal over the seed layer to fill recessed patterns in the wafer surface. Excess metal may then be removed by chemical mechanical polishing to form conductive features in the recessed patterns.

During electrodeposition, a wafer may be supported in a clamshell structure comprising a cup and a cone. The cup supports a wafer, and comprises a wafer interface including a plurality of electrical contacts positioned behind a lip seal. The cone holds a wafer positioned within the cup against the lip seal. The lip seal prevents plating solution from reaching the electrical contacts on the cup and corresponding electrical contacts on the wafer.

Maintaining consistent electrical contact between the wafer edge and the cup contacts helps to ensure the deposition of a suitably uniform metal layer and void-free filling of surface features. However, at times, the condition of the wafer interface may degrade during operation. As one example, the cup electrical contacts may become wet. Sources of wetness include the plating bath solution and water used to clean the interface between depositions. As a more specific example, liquid droplets from the plating bath may wet the electrical contacts during wafer handling.

Droplets from the plating bath on the wafer interface also may lead to crystal growth and/or other residual build-up on electrical contacts of the wafer interface. Such droplets can cause the seed layer on the wafer edge to dissolve and redeposit onto the electrical contacts of the cup during an electrodeposition process, forming residues. Further, organic additives in the plating bath may precipitate on the electrical contacts.

Wafer interface structures also may suffer mechanical damage. For example, electrical contacts of the wafer interface may be bent or broken during wafer transfer. Further, liquid droplets and/or residues on the wafer interface electrical contacts may cause wafer sticking during handling, further increasing the possibility of damaging the electrical contacts. A lip seal also may become damaged. This may allow plating solution to leak past the seal.

Any of the above-described wafer interface conditions may result in inconsistent electrical contact between the electrical contacts of the cup wafer interface and the electrical contacts on a wafer. Inconsistent electrical contact may degrade plating uniformity, and lead to defective wafers. Furthermore, metal dendrites may form around a contact that suffers from the above issues. Dendrite formation may lead to arcing that damages the electrodeposition tool.

Various maintenance processes may be used to help address such issues. For example, an electrodeposition tool may include hardware and control features to perform wafer interface cleaning operations. Example cleaning operations include rinsing and drying operations. Also, specialized cleaning procedures may be used to clean relatively tougher residues on a wafer interface electrical contact. Damaged electrical contacts may be fixed by removing the cup and either repairing or replacing the wafer interface.

However, detecting such conditions in time to perform preventative maintenance poses challenges. For example, frequent human visual inspection of a wafer interface may be time-consuming and costly. Thus, maintenance processes may be performed on a fixed schedule between multiple runs, instead of between each run. However, in some instances, wafer interface conditions may not be identified until quality assurance testing shows defective wafers. The resulting defective wafers may be unusable, and result in lower product yield.

Accordingly, examples are disclosed that relate to performing machine vision-based inspections of a wafer processing tool to classify the wafer processing tool either as healthy or as potentially needing maintenance. The term “classify” and the like as used herein signifies the categorization of the wafer processing tool in one or of a plurality of defined categories based upon a condition of the tool as determined from the machine vision inspection process. The classifications obtained by the machine-vision health inspections also may be used for automatically triggering maintenance processes. The use of a trained machine learning function may allow an inspection of a wafer processing tool to be performed at a higher frequency than a manual inspection with less, if any, impact on tool throughput. Further, the use of labeled training images that include hard-to-spot conditions to train the machine learning function may allow the machine learning function to quickly detect possible errors that would be difficult for the human eye to detect.

As a more specific example, an electrodeposition tool may utilize machine vision and a suitably trained machine learning function to inspect a wafer interface in a cup. In such an example, the machine learning function may be trained in a training phase to apply classifications such as “normal”, “wet”, “dirty”, “damaged”, and “ambiguous” using labeled training data corresponding to each of these classifications. Then, in a deployment phase, images of the wafer interface acquired via a camera may be input into the trained machine learning function. The trained machine learning function outputs probabilities that an image corresponds to each of a plurality of possible classifications. A highest probability may be used as a determined classification. Further, in some examples, the determined highest probability may be compared to a threshold probability. The corresponding classification may be assigned when the probability meets the threshold probability. Likewise, the corresponding classification may not be assigned when the classification does not meet the threshold probability. Instead, if the determined highest probability does not meet the probability threshold, a classification of “ambiguous” may be assigned.

In some examples, the image classification may be used to trigger a manual intervention process. For example, an image classification of “dirty” may prompt a tool operator to perform additional cleaning. Similarly, an image classification of “wet” may prompt the tool operator to perform additional drying. In other examples, the classification may be used to trigger an automatic maintenance program. For example, the electrodeposition tool may automatically perform a drying program in response to an image classification of “wet”. In another example, the electrodeposition tool may automatically perform a cleaning program in response to an image classification of “dirty”. Other maintenance program examples are discussed in more detail below.

As mentioned above, machine vision-based inspection processes for wafer processing tools may be faster to perform than a human visual inspection. As such, the inspection process may be performed frequently with less tool downtime. This may help to identify potentially harmful conditions promptly. As such, maintenance may be performed prior to defects arising in wafer processing. As such, the disclosed examples may help to reduce electrodeposition tool inspection costs, repair costs and tool downtime compared to manual visual inspections. This also may improve wafer yield.

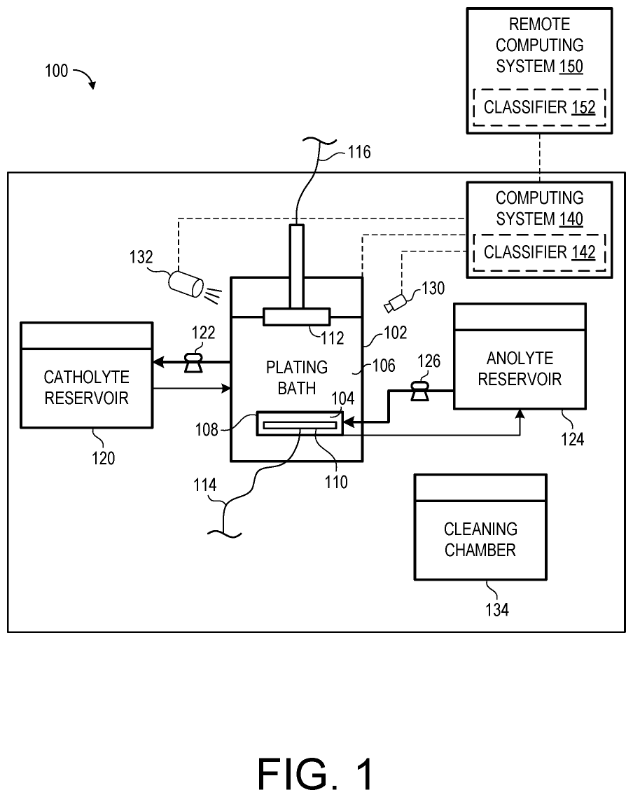

FIG. 1 schematically shows a block diagram of an example electrodeposition tool 100 configured to perform machine-vision based inspections of a wafer interface. While disclosed in the context of an electrodeposition tool, it will be understood that machine vision-based inspections according to the present disclosure may be used with any other suitable wafer processing tool.

Electrodeposition tool 100 comprises an electroplating cell 102 including an anode chamber 104 and a cathode chamber 106 separated by a selective transport barrier 108. Anode chamber 104 comprises an anode, indicated schematically at 110. Anode chamber 104 further comprises an anolyte solution in contact with anode 110. Cathode chamber 106 comprises further a plating solution, or catholyte, in contact with cathode 112. The plating bath contains an ionic species to be deposited on a wafer as a metal by electrochemical reduction. Anode 110 may comprise the metal being deposited, and oxidation of anode 110 may replenish the ionic species as the ionic species is consumed by the deposition process.

Selective transport barrier 108 allows a separate chemical and/or physical environment to be maintained within anode chamber 104 and cathode chamber 106. For example, selective transport barrier 108 may be configured to prevent non-ionic organic species from crossing the barrier while allowing metal ions to cross the barrier. The catholyte may be circulated between cathode chamber 106 and a catholyte reservoir 120 via a combination of gravity and one or more pumps 122. Likewise, the anolyte in anode chamber 104 may be stored in and replenished from an anolyte reservoir 124. Anolyte may be circulated through anolyte reservoir 124 and anode chamber 104 via a combination of gravity and one or more pumps 126.

In some integrated circuit fabrication systems, plating operations maybe performed in parallel on multiple wafers using multiple electrodeposition modules. In such cases, central catholyte and/or anolyte reservoirs may supply multiple plating cells with catholyte and/or anolyte.

During electroplating, an electric field is established between anode 110 and cathode 112. This field drives positive ions from anode chamber 104 through selective transport barrier 108 and into cathode chamber 106 and onto cathode 112. At the cathode, an electrochemical reaction takes place in which metal cations are reduced to form a solid layer of the metal on the surface of cathode 112. An anodic potential is applied to anode 110 via an anode electrical connection 114, and a cathodic potential is provided to cathode 112 via a cathode electrical connection 116. In some embodiments, the cathode/substrate may be rotated during electroplating.

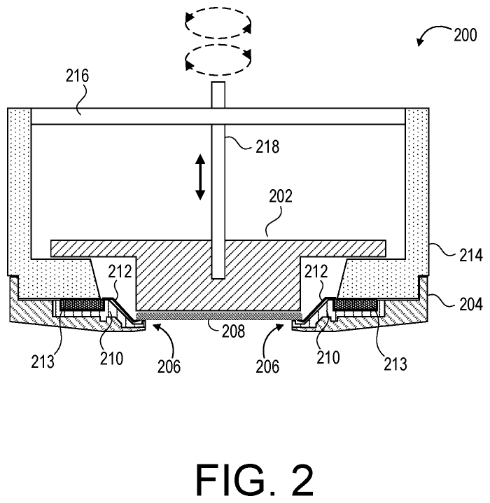

FIG. 2 shows a schematic sectional view of a clamshell assembly 200 configured to hold a wafer during an electrodeposition process. Clamshell assembly 200 is an example of a wafer holder suitable to hold cathode 112 of FIG. 1.

Clamshell assembly 200 comprises a cone 202 and a cup 204. Cup 204 comprises a wafer interface 206 that is configured to support a wafer 208, which is an example of a cathode 112 of FIG. 1. Wafer interface 206 comprises a lip seal 210 and a plurality of electrical contacts 212. Lip seal 210 makes physical contact with wafer 208 to prevent plating solution from reaching electrical contacts 212 during electrodeposition. Each electrical contact of the plurality of electrical contacts 212 make electrical contact with wafer 208 at a location behind lip seal 210. Electrical contacts 212 are attached to a metal frame 213, which provides mechanical support and electrical conduction.

Cup 204 is supported by struts 214, which connect to other portions of clamshell assembly 200, such as a vertical lift. A position of cone 202 relative to cup 204 is controllable to selectively press wafer 208 against lip seal 210 with cone 202, and to allow wafer 208 to be removed from cup 204. Clamshell assembly 200 further comprises a top plate 216 and a spindle 218. Spindle 218 may be mechanically connected to a motor controllable to rotate clamshell assembly 200. Wafer 208 may be lowered towards a plating bath such that the exposed surface of wafer 208 is immersed in the plating bath during electroplating. Downward force from cone 202 helps form a fluid tight seal between wafer 208 and lip seal 210 during electroplating. This helps to isolate electrical contacts 212 from the plating bath.

Each electrical contact 212 makes electrical contact at the edge of wafer 208. The position where each electrical contact touch wafer 208 can range from a few millimeters (mm) to less than 1 mm from the edge of wafer 208. In some examples, the electrical contacts may comprise a dense array (e.g., hundreds of electrical contacts) arranged in a shape of the wafer perimeter.

Returning to FIG. 1, electrodeposition tool 100 further comprises one or more cameras 130 and optionally one or more light sources 132. Each camera 130 is positioned to image at least a portion of a wafer interface of the cup during a machine vision inspection process. Camera 130 may comprise any suitable camera or cameras. Examples include one or more visible and/or infrared intensity cameras. Further, some examples and also may include one or more depth cameras, wherein the term “depth cameras” indicates a camera that resolves a distance from each pixel of an image sensor of the camera to a location in the physical environment imaged by that pixel. Each light source 132 is positioned to illuminate the wafer interface to provide for suitable and consistent lighting during an image acquisition process.

Electrodeposition tool 100 further comprises optional cleaning stations to help perform maintenance processes. In the depicted example, electrodeposition tool 100 comprises a cleaning chamber 134 for performing a cleaning program. After electrodeposition, the wafer may be removed from electroplating cell 102 and moved to cleaning chamber 134 for rinsing and drying. In some examples, cleaning chamber 134 can also be used to clean the wafer interface. Cleaning chamber 134 may be configured to perform one or more of a rinsing program, a specialized cleaning procedure (e.g., etching procedure), a drying program or other suitable cleaning program. Further, in some examples, electrodeposition tool 100 may be configured to immerse the wafer interface in acidic plating solution 106 to assist in cleaning.

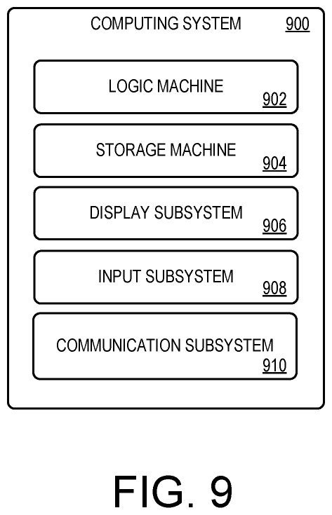

Electrodeposition tool 100 further comprises a computing system 140, aspects of which are described in more detail below with regard to FIG. 9. Computing system 140 comprises instructions executable to obtain images of the wafer interface via camera 130. Computing system 140 also comprises instructions executable to obtain classifications of the images from a locally executed or remotely executed trained machine learning classification function. Example machine learning classification functions are illustrated as classifier 142 and classifier 152. Further, computing system 140 may include instructions executable to perform maintenance routines, for example based upon image classifications obtained from the trained machine learning function. Computing system 140 also may include instructions executable to control any other suitable functions of electrodeposition tool 100, such as electrodeposition processes and wafer loading/unloading processes.

In some examples, computing system 140 may be configured to communicate with a remote computing system 150 via a suitable computer network. For example, computing system 140 may be configured to provide images from camera 130 to remote computing system 150 for the remote computing system to classify the image using classifier 152. In such examples, computing system 140 also receives classifications from remote computing system 150. As indicated by the dashed lines surrounding classifiers 142 and 152, the classifier may be executed locally and/or remotely. Remote computing system 150 may comprise any suitable computing system, such as a networked workstation computer, an enterprise computing system, and/or a cloud computing system, as examples. It will be understood that remote computing system 150 may be in communication with and control a plurality of electrodeposition tools in some examples.

As mentioned above, electrodeposition tool 100 is configured to execute a machine vision inspection process to locate possible problem conditions. The term “machine vision inspection process” as used herein comprises a process that utilizes image data and a trained machine learning classification function to assess a condition of a wafer processing tool. A machine vision inspection may be executed upon occurrence of any suitable trigger. For example, a machine vision inspection may be performed after a selected number of wafers have been processed and/or after a selected amount of time has passed. A machine vision inspection may be performed at regular intervals, or varying intervals. A machine vision inspection also may be performed after a maintenance program has been executed. This may help ensure that the wafer interface is clean, dry and undamaged after a cell cleaning program has been executed. As another example, the machine vision inspection may be executed whenever the electrodeposition tool is idle.

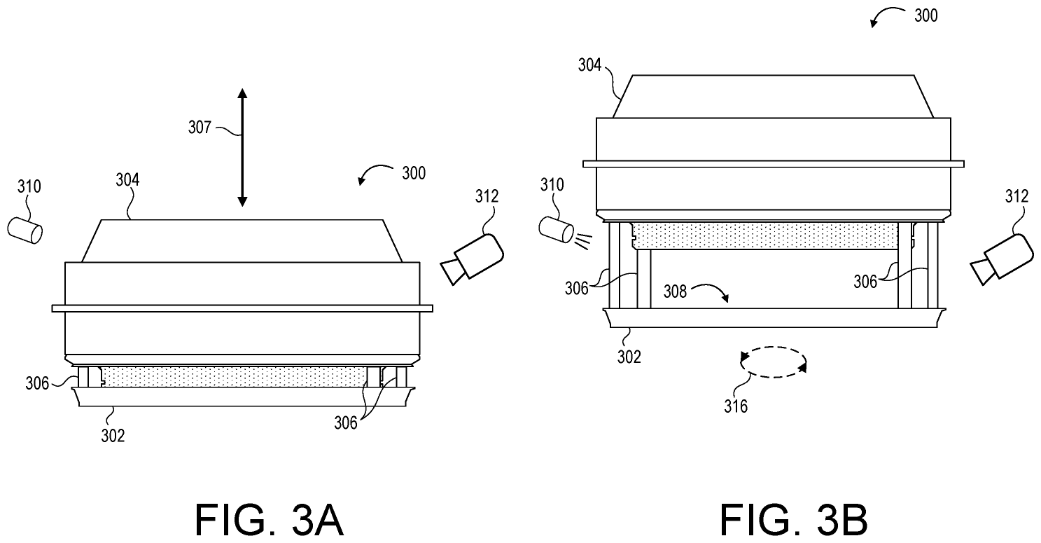

During a machine vision inspection process, a clamshell assembly of electrodeposition tool is opened (and wafer removed if necessary). Images are then acquired of the electrodes and/or lip seal of wafer interface. FIGS. 3A-3B illustrates an example clamshell assembly 300, and illustrates opening of clamshell assembly 300 to expose a wafer interface for imaging. Clamshell assembly 300 comprises a cup 302, a cone 304, and support struts 306. Clamshell assembly 300 is an example of clamshell assembly 200 of FIG. 2. Cup 302 is configured to support a wafer during an electrodeposition process. Cup 302 comprises a wafer interface 308 comprising a plurality of electrical contacts and a lip seal, which are not visible in the view of FIGS. 3A-3B.

During electrodeposition, a wafer is placed inside cup 302 and cone 304 presses the wafer against the lip seal of cup 302. Clamshell assembly 300 is mounted on a lift for vertical motion, as indicated schematically at 307. The lift moves the cup into the plating bath for electrodeposition. After the electrodeposition, the lift moves clamshell assembly out of the plating bath for rinsing and drying, e.g., in a cleaning chamber. Clamshell assembly 300 then opens again for wafer unloading.

As depicted in FIG. 3B, support struts 306 that connect cup 302 and cone 304 allow for cup 302 and cone 304 to be separated to thereby open clamshell assembly 300. Opening clamshell assembly 300 allows camera 312 to image at least a portion of wafer interface 308. During imaging, one or more light sources 310 may be controlled to illuminate the wafer interface. Further, in some examples, clamshell assembly 300 may be configured to rotate during imaging, as indicated at 316. In such examples, camera 312 can image wafer interface 308 at multiple angles of rotation. In other examples, multiple cameras may be used to image wafer interface from different angles, either with or without rotation. In yet other examples, a camera may be positioned to image an entirety of wafer interface 308. In such an example, the camera may be placed above a wafer interface, such as by being integrated with cone 304.

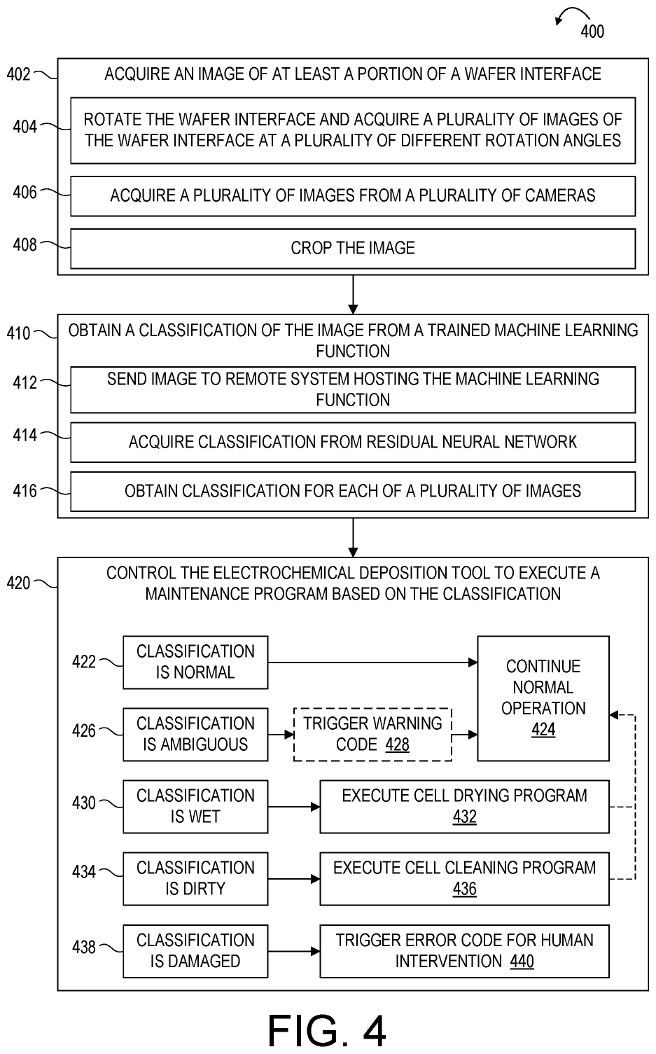

FIG. 4 shows a flow diagram of an example method 400 for operating an electrodeposition tool. For example, computing system 140 may execute method 400 as part of a machine vision inspection process of electrodeposition tool 100.

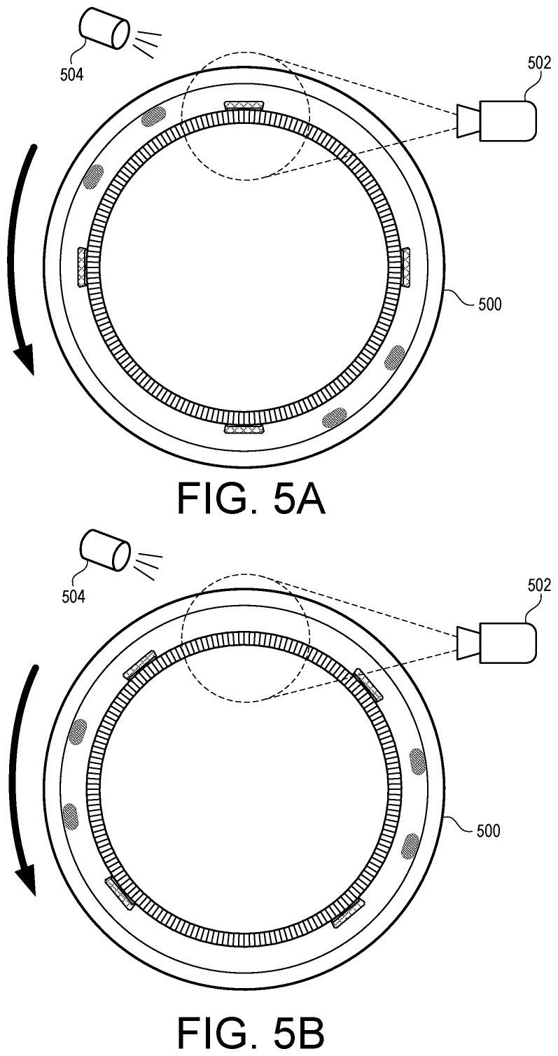

At 402, method 400 comprises acquiring an image of at least a portion of a wafer interface. As mentioned above, this may comprise rotating the wafer interface and acquiring a plurality of images of the wafer interface at a corresponding plurality of angles of rotation, as indicated at 404. FIGS. 5A-5B show a top view of an example wafer interface 500 that rotates relative to a camera 502 during a machine vision inspection process. As shown in FIG. 5A, camera 502 captures an image of a first portion of the wafer interface. Light source 504 illuminates wafer interface 500 during imaging. In some examples, a plurality of light sources may be used. Next, FIG. 5B shows wafer interface 500 after approximately 40° of rotation. Camera 502 then is operated to capture an image of a second portion of the wafer interface. In this manner, images of an entirety of the wafer interface may be serially acquired. Each image can then be classified using a trained machine learning function.

In some examples, the wafer interface rotates at a rate between 1-60 rotations per minute (RPM). In more specific examples, the wafer interface rotates at a rate of 2-10 RPM. In yet more specific examples, the wafer interface rotates at a rate of between 4-6 RPM. Camera 502 may comprise an imaging framerate such that a suitable number of images of the wafer interface are obtained per rotation. In some examples, image collection continues for one or more full rotations. In one example, the rotation rate is 5 RPM and the frame rate is 5 frames per second (fps) such that 60 images are captured per rotation. In another example, between 10-30 images are captured per rotation. In other examples, the camera may capture any suitable number of images per rotation. In some examples, the rotation rate and framerate are adjustable. It will be understood that FIGS. 5A-5B are drawn schematically and may omit certain features for clarity.

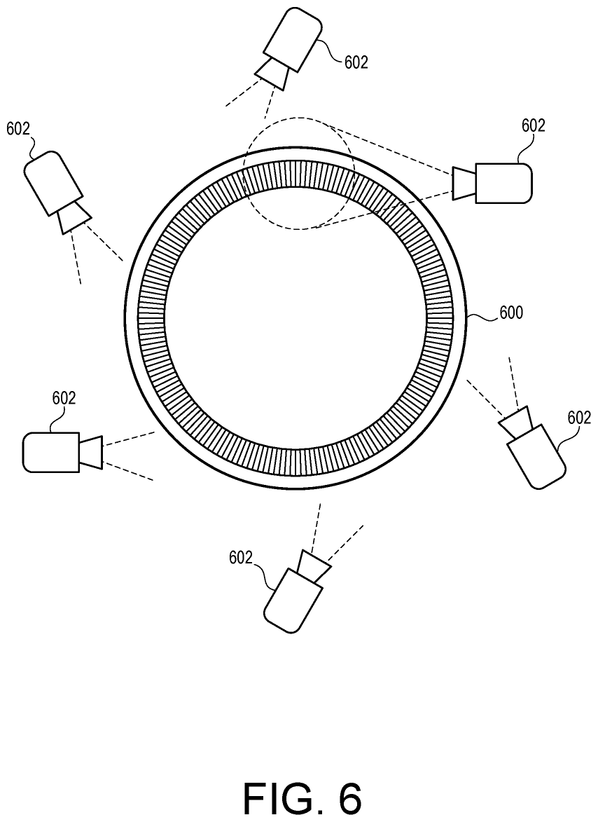

Returning to FIG. 4, in some examples, at 406, method 400 comprises acquiring a plurality of images of the wafer interface from a corresponding plurality of cameras. FIG. 6 schematically shows an example cup 600 and six cameras 602 configured to image the wafer interface of cup 600. Each camera 602 can image a different portion of the wafer interface. As such, a plurality of images of the wafer interface may be captured in parallel, with or without rotation of the cup. By imaging different portions of the wafer interface in parallel, a machine vision inspection process may be performed more quickly. While the example in FIG. 6 depicts six cameras, any suitable number of cameras may be used in other examples.

Continuing with FIG. 4, in some examples, at 408, method 400 comprises cropping the image. For example, the camera may be configured to focus a region of the image corresponding to a portion of the wafer interface, while leaving other image regions out of focus. In such examples, the image may be cropped to remove image regions that are not in focus and/or are not of interest in the classification. In one more specific example, an image with a resolution of 1600×1200 pixels is cropped to a size of 512×512 pixels. In other examples, any other suitable camera resolution and cropping size may be used. Further, in some examples, additional image preprocessing is employed, such as brightness correction, color correction, filtering, etc.

Method 400 further comprises, at 410, obtaining a classification of the image via a trained machine learning function. In some examples, the classification may be obtained by providing the image to a trained machine learning function that is local to the electrodeposition tool, while in other examples may be obtained by providing the image to a trained machine learning function that is remote to the electrodeposition too. Thus, in some examples, at 412, the method comprises sending the image to a remote computing system hosting the trained machine learning function. In such examples, the method further comprises obtaining the classification of the image from the remote computing system. Any suitable classifications may be applied, depending upon the content and labeling of the training data. Example classifications for an electrodeposition tool wafer interface comprise “normal”, “ambiguous”, “wet”, “dirty”, and “damaged”. In other examples, any other suitable classifications may be used.

Any suitable type of machine learning classifier may be used as the trained machine learning function to classify the wafer processing tool condition. In some examples, as indicated at 414, the trained machine learning function comprises a residual neural network (ResNet). In a more specific example, the trained machine learning model comprises a ResNet-18 model. Various details of such an example trained machine learning function are described in more detail below. Continuing with FIG. 4, where a plurality of images are acquired in a machine vision inspection process, method 400 comprises, at 416, obtaining a classification for each image of a plurality of images.

In some examples, the classification obtained may be used to trigger a manual action by a tool operator. For example, a classification of “ambiguous”, “wet”, “dirty”, or “damaged” each may trigger the output of an error code alerting the operator to the need for maintenance or inspection.

In other examples, the classification obtained may be used to trigger an automated maintenance program. As such, method 400 further may comprise, at 420, optionally controlling the electrodeposition tool to perform a maintenance program based on the classification. In the depicted example, when the classification is “normal”, at 422, then method comprises, at 424, continuing normal operation. On the other hand, other classifications may invoke specific maintenance actions. For example, where the classification is “ambiguous” at 426, the method comprises optionally triggering a warning code at 428 and continuing normal operation at 424. Triggering a warning code at 428 indicates to an operator a potential, but ambiguous, issue that may require further manual inspection.

As another example, at 430, where the classification is “wet,” method 400 further comprises, at 432, executing a cell drying program. In such an example, the cell may be further dried and then again inspected via machine vision prior to performing more wafer processing. As another example, at 434, where the classification is “dirty,” method 400 further comprises, at 436, executing a cell cleaning program. In some examples, the cell cleaning program comprises an additional cell rinse cycle. In other examples, the cell cleaning program comprises a more aggressive contact etch procedure to clean the electrical contacts. Further, in some examples, a cell cleaning program is followed by a cell drying program.

In some examples, after executing a cell drying program at 432 or executing a cell cleaning program at 436, the method proceeds to continue normal operation at 424. In other examples, the method may perform another machine vision process after executing a maintenance process. As such, if the new inspection result is “normal”, the method may continue normal operation of the wafer processing tool. On the other hand, when a subsequent inspection processes obtains a classification other than “normal”, the method may trigger the output of an error code for human intervention. The method alternatively or additionally may perform additional automatic maintenance programs upon obtaining a classification other than “normal” after performing a first maintenance program.

Continuing, at 438, where the classification is “damaged,” method 400 further may comprise, at 440, triggering the output of an error code for human intervention. In some examples, such a classification also may result in disabling of the wafer processing tool until the damaged component (e.g. electrodes, lip seal, or other suitable structure) is fixed.

In some examples, a plurality of images of a wafer interface or other tool component are classified, such that more than one classification is obtained. In some such examples, a most serious classification may be chosen as the overall classification for the wafer interface. For example, if some images are classified as “wet” and some images are classified as “dirty”, the overall classification of the wafer interface is “dirty”. Dirty may be considered a more serious condition than wet. This is because a “dirty” classification may require cleaning and drying. In contrast a “wet” classification may require drying only. Likewise, if at least one image is classified as “damaged”, the overall classification of the wafer interface will be “damaged”. As such, a “normal” classification may only apply if all images are classified as “normal”.

In some examples, method 400 further comprises outputting an inspection report. Such a report may comprise such as electrodeposition tool identification number, date, time, classification, maintenance program executed, and/or an image of a wafer interface, in various examples.

As mentioned above, a trained machine learning function used to classify images of a wafer processing tool may have any suitable architecture. Suitable classifiers include artificial neural networks, such as deep neural networks, recurrent neural networks, and convolutional neural networks. Suitable classifiers also include other types of machine learning models, such as decision trees, random forests, and support vector machines, depending upon a number and type of classifications to be supported.

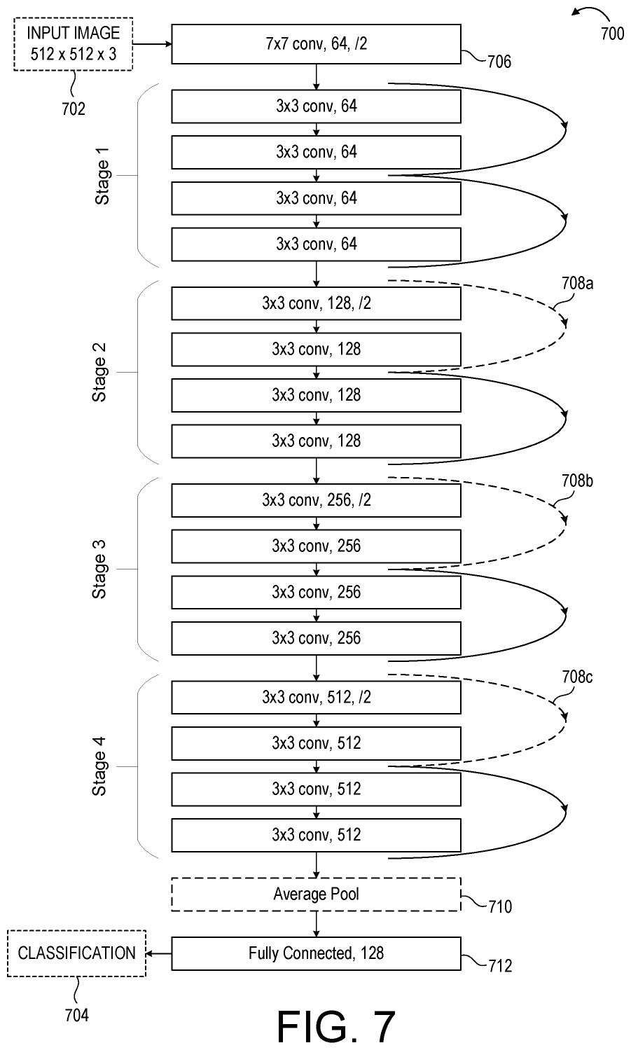

Artificial neural networks may be well-suited for machine vision tasks. An artificial neural network according to the present disclosure for classifying a wafer processing tool may comprise any suitable number and arrangement of layers. Some examples may utilize a residual neural network (ResNet). A ResNet is an artificial neural network that comprises skip connections. The skip connections may help avoid issues with vanishing gradients that can occur when training a neural network with a relatively larger number of layers. FIG. 7 schematically shows the architecture of an example ResNet 700 comprising 18 convolutional layers, also referred to as ResNet-18. ResNet 700 accepts an image 702 as input and outputs a classification 704. Input image 702 is a 512×512 RGB image and thus has dimensionality of 512×512×3, where the third dimension relates to a number of color channels (e.g. red, green, blue). In other examples, a ResNet may be configured to accept images of different dimensions.

ResNet 700 comprises a first convolutional layer 706 comprising a kernel size of 7×7, 64 output channels, and a stride of 2. ResNet 700 comprises 16 convolutional layers arranged in four stages. Each stage comprises four convolutional layers and a number of normalization layers and ReLU layers (omitted for clarity). ResNet700 further comprises skip connections 708a-c. ResNet 700 also comprises a 7×7 average pool 710 and a fully connected layer 712 for classification. The output from fully connected layer 712 provides the classification 704 via a soft-max operation. In some examples, the output further comprises a determined probability associated with the classification. In the depicted example, double-layer skip connections are employed, the kernel sizes range from 3×3 to 7×7, and the number of channels range from 64 to 1000. In other examples, any suitable parameters may be used. The example of FIG. 7 is intended to be illustrative and not limiting, and any other suitable ResNet may be used. Other illustrative examples include ResNet-34, ResNet-50, and ResNet-101.

Any suitable method may be used to train a machine learning classifier according to the present disclosure. A particular training algorithm will depend upon a type of machine learning function employed. The machine learning function may be trained via supervised training using a set of labeled training images. The training images may comprise images of wafer interfaces labeled as one of “normal”, “wet”, “dirty”, or “damaged”. In other examples, other classification labels may be used. Once trained, the trained machine learning function is used to classify an image of a wafer interface and output a classification. In some examples, the trained machine learning function also provides a confidence score with the classification. The confidence score may correspond to a determined probability. In some examples, when the confidence score for the most likely classification does not exceed a threshold, the trained machine learning function may output an indication of an indeterminate classification, such as “ambiguous”. This may occur, for example, when the content of the image is not of sufficient quality for classification. For example, images that are relatively bright, relatively dark, or otherwise do not contain a view of the wafer interface may provide ambiguous classification results.

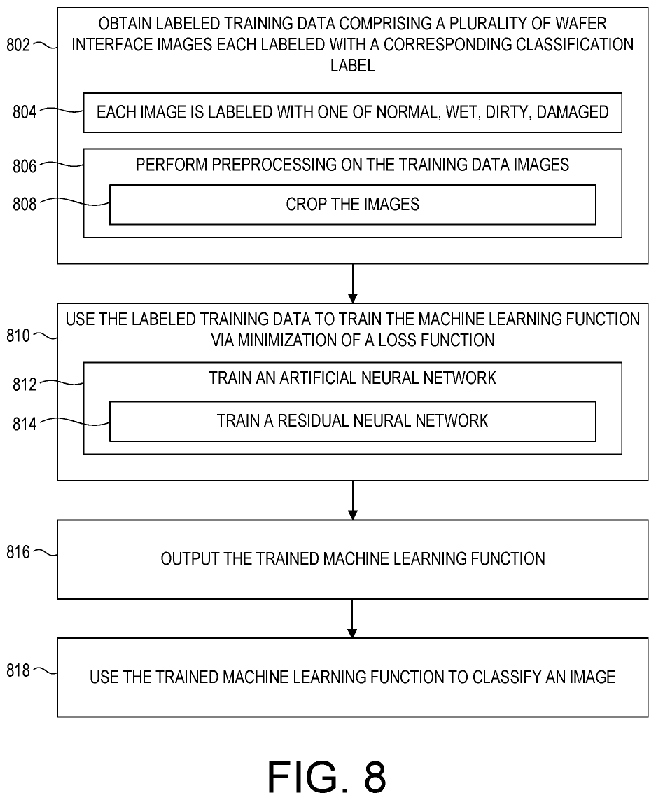

FIG. 8 shows a flow diagram of an example method 800 for training a machine learning function to classify images of a wafer interface. At 802, the method comprises obtaining labeled training data comprising a plurality of wafer interface images each labeled with a corresponding classification. In some examples, at 804, each image is labeled with one of “normal”, “wet”, “dirty”, or “damaged”. In other examples, any other suitable labels may be used. Further, in some examples, at 806, method 800 comprises performing preprocessing on the training data images. In some examples, at 808, the preprocessing comprises cropping the images.

Method 800 further comprises, at 810, using the labeled training data to train the machine learning function via minimization of a loss function. In some examples, at 812, the method comprises training an artificial neural network. In some examples, the method employs backpropagation to determine gradients. In some examples, at 814, the artificial neural network is a ResNet. When training a ResNet, the training process may utilize skip weights, which are weighting factors applied to the skip connections in the ResNet.

Continuing, at 816, the method comprises outputting the trained machine learning function. At 818, the method comprises using the trained machine learning function to classify an image of a wafer interface and output a classification.

Machine vision-based inspection processes for wafer processing tools as disclosed may be faster to perform than a human visual inspection. As such, the inspection process may be performed frequently with less tool downtime. This may help to identify potentially harmful conditions promptly. As such, preventative maintenance may be performed prior to defects arising in wafer processing. This may help to reduce electrodeposition tool inspection costs, repair costs and tool downtime compared to manual visual inspections. This also may improve wafer yield.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 9 schematically shows a non-limiting embodiment of a computing system 900 that can enact one or more of the methods and processes described above. Computing system 900 is shown in simplified form. Computing system 900 may take the form of one or more personal computers, workstations, computers integrated with wafer processing tools, and/or network accessible server computers.

Computing system 900 includes a logic machine 902 and a storage machine 904. Computing system 900 may optionally include a display subsystem 906, input subsystem 908, communication subsystem 910, and/or other components not shown in FIG. 9. Computing system 140 and remote computing system 150 are examples of computing system 900.

Logic machine 902 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 904 includes one or more physical devices configured to hold instructions executable by the logic machine to implement the methods and processes described herein. When such methods and processes are implemented, the state of storage machine 904 may be transformed—e.g., to hold different data.

Storage machine 904 may include removable and/or built-in devices. Storage machine 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 904 may include volatile, nonvolatile, dynamic, static, read/write, read-only, random-access, sequential-access, location-addressable, file-addressable, and/or content-addressable devices.

It will be appreciated that storage machine 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 902 and storage machine 904 may be integrated together into one or more hardware-logic components. Such hardware-logic components may include field-programmable gate arrays (FPGAs), program- and application-specific integrated circuits (PASIC/ASICs), program-and application-specific standard products (PSSP/ASSPs), system-on-a-chip (SOC), and complex programmable logic devices (CPLDs), for example.

When included, display subsystem 906 may be used to present a visual representation of data held by storage machine 904. This visual representation may take the form of a graphical user interface (GUI). As the herein described methods and processes change the data held by the storage machine, and thus transform the state of the storage machine, the state of display subsystem 906 may likewise be transformed to visually represent changes in the underlying data. Display subsystem 906 may include one or more display devices utilizing virtually any type of technology. Such display devices may be combined with logic machine 902 and/or storage machine 904 in a shared enclosure, or such display devices may be peripheral display devices.

When included, input subsystem 908 may comprise or interface with one or more user-input devices such as a keyboard, mouse, or touch screen. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition, and an infrared, color, stereoscopic, and/or depth camera for machine vision and/or gesture recognition.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local-or wide-area network. In some embodiments, the communication subsystem may allow computing system 900 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. An electrodeposition tool, comprising:
a cup comprising a wafer interface, the wafer interface comprising a lip seal and a plurality of electrical contacts;
a camera positioned to image at least a portion of the wafer interface;
a logic machine; and
a storage machine storing instructions executable by the logic machine to:
acquire an image of the wafer interface via the camera,
obtain a classification of the image of the wafer interface from a trained machine learning function, and
control the electrodeposition tool to take an action based on the classification.

2. The electrodeposition tool of claim 1, wherein the wafer interface is configured to rotate, and wherein the camera is configured to capture a plurality of images of the wafer interface at a corresponding plurality of angles of rotation of the wafer interface.

3. The electrodeposition tool of claim 2, wherein the instructions are executable to obtain a classification of each image of the plurality of images.

4. The electrodeposition tool of claim 1, wherein the instructions are executable to transmit the image of the wafer interface to a remote computing system hosting the trained machine learning function, and to obtain the classification of the image from the remote computing system.

5. The electrodeposition tool of claim 1, wherein the trained machine learning function comprises a residual neural network.

6. The electrodeposition tool of claim 1, wherein the instructions are executable to control the electrodeposition tool to execute a cleaning program in response to obtaining a classification of dirty.

7. The electrodeposition tool of claim 1, wherein the instructions are executable to control the electrodeposition tool to execute a cell drying program in response to obtaining a classification of wet.

8. The electrodeposition tool of claim 1, wherein the instructions are executable to control the electrodeposition tool to output an error code for user intervention in response to obtaining a classification of damaged.

9. The electrodeposition tool of claim 1, wherein the instructions are executable to control the electrodeposition tool to continue normal operation in response to obtaining a classification of one of normal or ambiguous.

10. A method for operating an electrodeposition tool, the method comprising:
acquiring an image of a wafer interface of the electrodeposition tool via a camera;
obtaining a classification of the image from a trained machine learning function; and
upon obtaining the classification, controlling the electrodeposition tool to execute a maintenance program based upon the classification.

11. The method of claim 10, wherein the classification comprises a dirty classification, and the maintenance program comprises a cell cleaning program.

12. The method of claim 10, wherein the classification comprises a wet classification, and the maintenance program comprises a cell drying program.

13. The method of claim 10, wherein the classification comprises a damage classification, and the maintenance program comprises triggering output of an error code for user intervention.

14. The method of claim 10, further comprising acquiring a plurality of images of the wafer interface at a corresponding plurality of angles of rotation of the wafer interface, and obtaining a classification of each image of the plurality of images from the trained machine learning function.

15. The method of claim 10, further comprising obtaining a classification of normal, and controlling the electrodeposition tool to continue normal operation.

16. The method of claim 10, further comprising obtaining an ambiguous classification, and, in response, triggering a warning code.

17. A computing system comprising:
a logic machine; and
a storage machine holding instructions executable by the logic machine to
obtain an image of a wafer interface of an electrodeposition tool, the wafer interface comprising a lip seal and a plurality of electrical contacts,
obtain a classification via inputting the image into a trained machine learning function, and
output the classification.

18. The computing system of claim 17, wherein the trained machine learning function comprises a residual neural network.

19. The computing system of claim 17, wherein the instructions are further executable to crop the image of the wafer interface prior to inputting the image into the trained machine learning function.

20. The computing system of claim 17, wherein the instructions are further executable to train the trained machine learning function using labeled training images that are each labeled with a classification of one of normal, wet, dirty, or damaged.
